(19) United States
(12) Patent Application Publication
(10) Pub. No.: US 2022/0330202 A1
(43) Pub. Date: Oct. 13, 2022

(54) METHOD AND SYSTEM FOR PROVIDING PAGING CAUSE TO MUSIM USER EQUIPMENT

(71) Applicant: Samsung Electronics Co., Ltd., Suwon-si, Gyeonggi-do (KR)

(72) Inventors: Lalith KUMAR, Bangalore (IN); Anikethan Ramakrishna Vijaya KUMAR, Bangalore (IN); Kundan TIWARI, Bangalore (IN)

(21) Appl. No.: 17/765,824

(22) PCT Filed: Sep. 29, 2020
(86) PCT No.: PCT/KR2020/013403

§ 371 Date: Mar. 31, 2022

(30) Foreign Application Priority Data
Oct. 4, 2019 (IN) 201941040359
Oct. 4, 2019 (IN) 201941040406
Nov. 19, 2019 (IN) 201941047165
Sep. 28, 2020 (IN) 201941040359

(51) Int. Cl. H04W 68/00; H04W 60/00

(52) U.S. Cl. CPC H04W 68/005; H04W 60/00; H04W 88/06

(57) ABSTRACT

The present disclosure relates to a 5G communication system or a 6G communication system for supporting higher data rates beyond a 4G communication system such as long term evolution (LTE).

Embodiments herein provide a method of an Access and Mobility management Function (AMF) controller in a wireless communication network. The method includes receiving, from a Multi Universal SIM User Equipment (MUSIM UE), a NAS request message including an AI request indicating a request for a paging cause in a paging message. Further, the method includes storing the AI request received in the NAS request message. Further, the method includes providing a NAS response message including an AI to the MUSIM UE, wherein the AI indicates whether the paging cause will be provided to the MUSIM UE as part of one of a paging procedure and a NAS notification procedure.

### CROSS-REFERENCE TO RELATED APPLICATIONS

This application is a National Phase Entry of PCT International Application No. PCT/KR2020/013403, which was filed on Sep. 29, 2020, and claims priority to Indian Provisional Patent Application No. 201941040406 filed on Oct. 4, 2019, and claims priority to Indian Provisional Patent Application No. 201941040359 filed on Oct. 4, 2019, and claims priority to Indian Provisional Patent Application No. 201941047165 filed on Nov. 19, 2019, and Indian Complete Patent Application No. 201941040359 filed on Sep. 28, 2020, in the Indian Intellectual Property Office, the content of each of which are incorporated herein by reference.

### BACKGROUND

### 1. Field

The present disclosure relates to cellular systems, and more specifically to a method and a system for providing a paging cause to a Multiple Universal Subscriber Identity Module (MUSIM) User Equipment (UE) in a wireless communication network.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100pec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

A cellular network provides an Assistance Information (AI) to a MUSIM UE as part of a paging message, where the paging message is considered as a costly resource. The cellular network consumes resources for deriving a value of the AI at each time whenever the MUSIM UE needs to be paged. Therefore, providing the AI to the MUSIM UE is an unnecessary operation and a wastage of the resources unless the cellular network receives a request for the AI by the MUSIM UE.

The cellular network delivers control plane messages over a signalling radio bearer, where the control plane messages are prioritised in default over an internet Packet Switched (PS) data. The control plane messages such as steering of roaming information, a routing ID update, network slice configurations, a UE policy delivery, Non-Access Stratum (NAS) Control Plane (CP) messages etc. are important for smooth functioning of the MUSIM UE. The control plane messages and the internet PS data needs to be differentiated and indicated to the MUSIM UE over one USIM as part of a paging procedure or a notification procedure. Hence, the MUSIM UE can make a proper decision on whether to respond to the paging message or not while accessing an ongoing service over other USIM.

Consider an example scenario, where the MUSIM UE is in an IDLE mode over a first USIM and a connected mode over a second USIM. The cellular network of the first USIM initiates a deregistration procedure with “re-registration” required flag. When a deregistration request (e.g. CP message) is not differentiated by the cellular network of the first USIM, the AI would be “other-data”. Further, the MUSIM UE may neglect the paging message by assuming that a PS data is pending, in response to receiving the paging message from the cellular network of the first USIM. Further, the cellular network of the first USIM will have to do local detach, and the MUSIM UE assumes that the MUSIM UE is registered with the cellular network of the first USIM. Further, the MUSIM UE will get into a permanent out of service from MT perspective. When the MUSIM UE initiates a MO operation, then the MUSIM UE receives “Implicitly detach” AI, which causes the UE to perform registration procedure and eventually an MO service will get delayed. Further, there are also some set of information elements such as SOR information, routing ID, any change in network slice information etc. which needs to be provided to the MUSIM UE in real time. The information elements are important for proper functioning of the MUSIM UE. Thus, it is better to differentiate the control plane messages in comparison with the internet PS data also called as user plane data, which allows the MUSIM UE to make the proper decision on whether to respond to the paging message or not.

Consider another example scenario, where the MUSIM UE is having a Mission Critical Service (MCS) related Packet Data Unit (PDU) session and an internet PDU session (i.e. the user plane data) over the first USIM. The second USIM is for personnel use on which only call is allowed as per a user configuration. Consider, the second USIM is busy due to a call or a PLMN search operation. When a downlink data is triggered for the MCS, then MUSIM UE may assume that triggering of the downlink data is for the internet PDU session and neglects the paging message, which impacts accessing of the MCS. Also, when the downlink data is triggered for the internet PDU sessions on the first USIM, and if the MUSIM UE assumes that the triggering is for the MCS PDU session, then the MUSIM UE responds to the paging message, which impacts on the call or the PLMN search operation performing using the second USIM.

FIG. 1 illustrates a signaling diagram between the MUSIM UE 100 and cellular networks 300A-300B for providing a paging message to the MUSIM UE 100 while the MUSIM UE 100 is using a service. Consider, a service-1 is ongoing (101) between the MUSIM UE 100 and a first network 300A corresponds to the first USIM of the MUSIM UE 100. A second network 300B corresponds to the second USIM of the MUSIM UE 100 initiates (102) a service-2 for the MUSIM UE 100. The AMF controller triggers a first paging procedure by sending (103) a first paging message with an AI value of AI−1 to the MUSIM UE 100 through the second RAN 300B. Consider, the MUSIM UE 100 decides (104) to not respond to the first paging message due to the AI value of AI−1, whereas the MUSIM UE 100 might have responded for a second paging message with an AI value AI−2. Meanwhile, the second network 300B initiates (105) a service-3 with the AI value AI−2 for the MUSIM UE 100. When the second paging message is a low priority message compared to the first paging message, then the second network 300B discards the second paging message or delays sending the second paging message till a response for the first paging message receives from the MUSIM UE 100, which affects a user experience.

Optionally, the second network 300B waits for a time the first paging procedure to complete for sending the second paging request, where the time is called as Paging Duration (PD). The second network 300B sends the second paging message to the MUSIM UE 100 after PD by escalating the first paging procedure. After expiring the PD, the second network 300B sends (107) the second paging request with the AI value AI−2 to the MUSIM UE 100. Further, the MUSIM UE 100 responds to the second paging message with an AI value AI−2. However, the second paging request with the AI value AI−2 to the MUSIM UE 100 after the PD, which affects a user experience. Thus, it is desired to address the above-mentioned shortcomings or at least provide a useful alternative.

### SUMMARY

The principal object of the embodiments herein is to provide a method and a system for providing a paging cause to a MUSIM UE in a wireless communication network. Therefore, the MUSIM UE can make an appropriate decision in response to knowing about triggering of services through the paging cause.

Another object of the embodiments herein is to indicate a request for the paging cause in a paging message to an Access and Mobility management Function (AMF) controller.

Another object of the embodiments herein is to send an AI request received from the MUSIM UE to a RAN for making a decision whether to provide the paging cause to the MUSIM UE.

Another object of the embodiments herein is to determine whether to respond to the paging message or not respond to the paging message by the MUSIM UE based on an identification that the paging cause is supported by the wireless communication network. Therefore, the method allows the MUSIM UE make the appropriate decision based on an identification that the paging cause is supported by the wireless communication network.

Another object of the embodiments herein is to send a second paging message includes at least one paging cause of services pending to deliver for the MUSIM UE even the MUSIM UE is not responded for a first paging message. Therefore, the method allows the MUSIM UE to know about all the services pending to receive even the MUSIM UE is not responded for a first paging message.

### BRIEF DESCRIPTION OF THE DRAWINGS

This method and apparatus are illustrated in the accompanying drawings, throughout which like reference letters indicate corresponding parts in the various figures. The embodiments herein will be better understood from the following description with reference to the drawings, in which:

FIG. 1 illustrates a signaling diagram between a MUSIM UE and cellular networks for providing a paging message to the MUSIM UE while the MUSIM UE is using a service, according to a prior art;

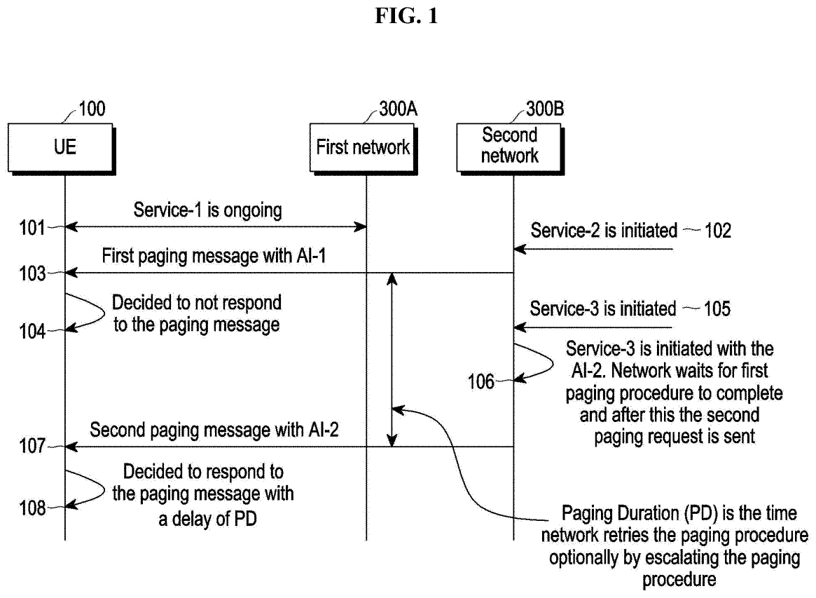

FIG. 2A is a block diagram of the MUSIM UE for managing a paging cause in a wireless communication network, according to an embodiment as disclosed herein;

FIG. 2B illustrates a system for providing the paging cause to the MUSIM UE in the wireless communication network, according to an embodiment as disclosed herein;

FIG. 3 is a flow diagram illustrating a method for providing the paging cause to the MUSIM UE in the wireless communication network, according to an embodiment as disclosed herein;

FIG. 4 is a flow diagram illustrating a method for managing the paging cause in the wireless communication network, according to an embodiment as disclosed herein;

FIG. 5 is a signaling diagram illustrating a registration procedure in the wireless communication network, according to an embodiment as disclosed herein;

FIG. 6 is a signaling diagram illustrating a procedure for providing an AI in a CM_IDLE state in the wireless communication network, according to embodiments as disclosed herein;

FIG. 7 is a signaling diagram illustrating a procedure for providing the AI in the RRC Inactive state in the wireless communication network, according to embodiments as disclosed herein;

FIG. 8 is a signaling diagram illustrating initiating a second paging procedure by an AMF controller or a gNodeB even when a first paging procedure is incomplete, according to the embodiments as disclosed herein;

FIG. 9 is a signalling diagram illustrating a transmission of the second paging message with multiplexing AI values by the AMF controller or the gNodeB, according to the embodiments as disclosed herein; and

FIG. 10 is a signalling diagram illustrating a scenario of triggering a NAS or AS procedure by the MUSIM UE to inform a deactivated state of the service to a second RAN, according to the embodiments as disclosed herein.

### DETAILED DESCRIPTION

Accordingly, the embodiments herein provide a method for providing a paging cause to a MUSIM UE in a wireless communication network. The method includes sending, by the MUSIM UE, a Non-Access Stratum (NAS) request message including an AI request indicating a request for the paging cause in a paging message to an AMF controller. Further, the method includes receiving, by the AMF controller, the NAS request message with the AI request from the MUSIM UE. Further, the method includes storing, by the AMF controller, the AI request received in the NAS request message. Further, the method includes providing, by the AMF controller, a NAS response message including the AI to the MUSIM UE, where the AI indicates whether the paging cause will be provided to the MUSIM UE as part of one of a paging procedure and a NAS notification procedure.

In an embodiment, where providing, by the AMF controller, the NAS response message including the AI to the MUSIM UE, includes sending, by the AMF controller, the AI request received from the MUSIM UE to a RAN for making a decision whether to provide the paging cause to the MUSIM UE, receiving, by the RAN, the MUSIM AI from the AMF controller, and providing, by the RAN, the paging message including the paging cause to the MUSIM UE in an RRC inactive state as part of a RAN paging procedure in response to determining that AMF AI indicates to provide the paging cause to the MUSIM UE.

In an embodiment, where the paging cause includes mission critical services, multimedia priority services, emergency services (also called as critical services).

In an embodiment, where the paging cause also includes an Instant Message Service (IMS) and non-IMS based voice service, an IMS and non-IMS based Short Message Service (SMS)/Unstructured Supplementary Service Data (USSD), an IMS service other than voice/SMS, a CP signaling, and other data/other services/default.

In an embodiment, further the method includes receiving, by the MUSIM UE, the paging message from the AMF controller. Further, the method includes determining, by the MUSIM UE, that the paging message includes an indication that the paging cause is supported by the wireless communication network, where the indication can include a new paging cause value or a new dedicated indication. Further, the method includes determining, by the MUSIM UE, whether to respond to the paging message or not respond to the paging message based on the identification that the paging cause is supported by the wireless communication network.

In an embodiment, where responding to the paging message, includes sending, by the MUSIM UE, a service request or a registration request message to the AMF controller to establish a NAS signaling connection, and receiving, by the MUSIM UE, an incoming service from the AMF controller when the MUSIM UE is in an idle state or sending of an RRC message to a gNodeB and get into a connected mode when the MUSIM UE is in an inactive state. i.e. in general, the MUSIM UE responds to the network with the NAS or AS message and getting the MUSIM UE into the connected mode.

In an embodiment, where not responding to the paging message, includes performing, by the MUSIM UE, one of: ignoring the paging message, and sending a NAS message or AS message with busy indication to the network.

In an embodiment, further the method includes detecting, by the AMF controller, a trigger for a second paging message with a second paging cause. Further the method includes sending, by the AMF controller, the second paging message to the MUSIM UE, where the second paging message includes at least one paging cause which is different from the paging cause of first paging message to the MUSIM UE.

Accordingly, the embodiments herein provide the MUSIM UE for managing the paging cause in the wireless communication network. The MUSIM UE includes an AI controller, a memory, and a processor, where the AI controller is coupled to the memory and the processor. The AI controller is configured to send the NAS request message including the AI request indicating a request for the paging cause in a paging message to the AMF controller. Further, the AI controller is configured to receive the NAS response message including the AI, wherein the AI indicates whether the paging cause will be provided to the MUSIM UE as part of one of the paging procedure and the NAS notification procedure.

Accordingly, the embodiments herein provide a system for providing the paging cause to the MUSIM UE in the wireless communication network. The system includes the RAN and the AMF controller. The AMF controller is configured to receive the NAS request message with the AI request from the MUSIM UE, where the AI request indicates the request for the paging cause in the paging message. The AMF controller is configured to store the AI request received in the NAS request message. The AMF controller is configured to provide the NAS response message including an AI to the MUSIM UE, where the AI indicates whether the paging cause will be provided to the MUSIM UE as part of one of the paging procedure and the NAS notification procedure.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g. one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method for providing a paging cause to a Multi Universal SIM User Equipment (MUSIM UE) in a wireless communication network. The method includes sending, by the MUSIM UE, a Non-Access Stratum (NAS) request message including an Assistance Information (AI) request indicating a request for the paging cause in a paging message to an Access and Mobility management Function (AMF) controller. Further, the method includes receiving, by the AMF controller, the NAS request message with the AI request from the MUSIM UE. Further, the method includes storing, by the AMF controller, the AI request received in the NAS request message. Further, the method includes providing, by the AMF controller, a NAS response message including an AI to the MUSIM UE, where the AI indicates whether the paging cause will be provided to the MUSIM UE as part of one of a paging procedure and a NAS notification procedure.

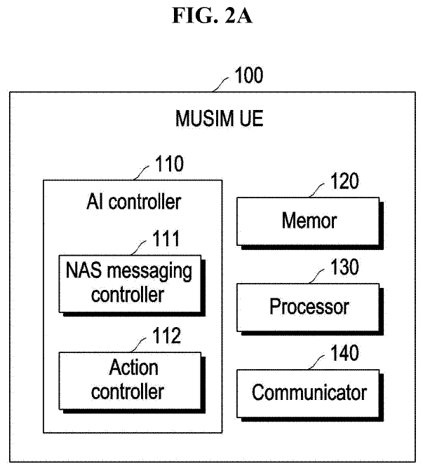

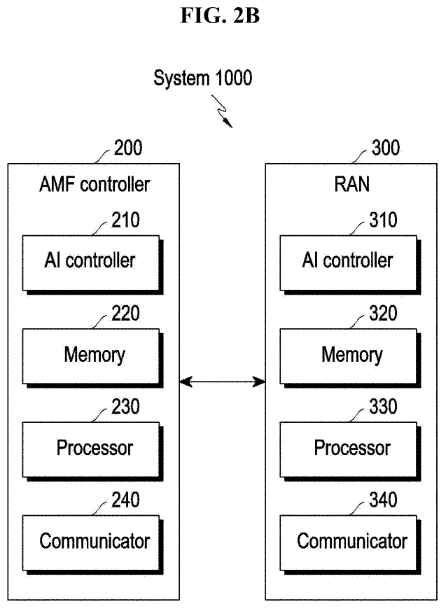

Referring now to the drawings, and more particularly to FIGS. 2A through 10, there are shown preferred embodiments.

FIG. 2A is a block diagram of a MUSIM UE 100 for managing a paging cause in a wireless communication network, according to an embodiment as disclosed herein. Examples for the MUSIM UE 100 are, but not limited to a smart phone, a tablet computer, a personal digital assistance (PDA), an Internet of Things (IoT), and the like. In an embodiment, the MUSIM UE 100 includes an AI controller 110, a memory 120, a processor 130, and a communicator 140. The AI controller 110 is coupled to the memory 120 and the processor 130. In an embodiment, the AI controller 110 includes a NAS messaging controller 111 and an action controller 112. An example for the wireless communication network is a cellular network includes an AMF controller 200 (shown in FIG. 2B) and at least one Radio Access Networks (RAN) 300 (shown in FIG. 2B). A gNodeB is an example for a RAN. In an embodiment, the paging cause comprises mission critical services, multimedia priority services, emergency services (also called as critical services), an Instant Message Service (IMS) and non-IMS based voice service, an IMS and non-IMS based Short Message Service (SMS)/Unstructured Supplementary Service Data (USSD), an IMS service other than voice/SMS, a CP signaling, and other data.

The AI controller 110 is configured to send a NAS or AS request message including an AI request indicating a request for the paging cause in a paging message to the AMF controller 200. Further, the AI controller 110 is configured to receive a NAS or AS response message including the AI, where the AI indicates whether the paging cause will be provided to the MUSIM UE 100 as part of one of a paging procedure and a NAS notification procedure. The AI controller 110 is configured to receive the paging message from the AMF controller 200. Further, the AI controller 110 is configured to determine that the paging message comprises an indication that the paging cause is supported by the wireless communication network, where the indication can include a new paging cause value or a new dedicated indication. Further, the AI controller 110 is configured to determine whether to respond to the paging message or not respond to the paging message based on the identification that the paging cause is supported by the wireless communication network.

In an embodiment, the NAS messaging controller 111 sends the NAS request message to the AMF controller 200. The NAS messaging controller 111 receives the NAS response message including the AI. The NAS messaging controller 111 receives the paging message from the AMF controller 200. The NAS messaging controller 111 determines that the paging message comprises an indication that the paging cause is supported by the wireless communication network. The NAS messaging controller 111 identifies that the paging cause in the paging message is to indicate that the paging cause is supported by the wireless communication network. The action controller 112 determines whether to respond to the paging message or not respond to the paging message based on the identification that the paging cause is supported by the wireless communication network

In an embodiment, responding to the paging message, includes sending, by the action controller 112, a service request or a registration request message to the AMF controller 200 to establish a NAS signaling connection, and receiving, by the action controller 112, an incoming service from the AMF controller 200 when the MUSIM UE 100 is in an idle state or sending of an RRC message to a gNodeB and get into a connected mode when the MUSIM UE 100 is in an inactive state. i.e. in general, the MUSIM UE 100 responds to the network with the NAS or AS message and getting the MUSIM UE 100 into the connected mode.

In an embodiment, not responding to the paging message includes ignoring the paging message by the action controller 112 or sending a NAS message or AS message with busy indication to the network by the action controller 112.

The memory 120 may include non-volatile storage elements. Examples of such non-volatile storage elements may include magnetic hard discs, optical discs, floppy discs, flash memories, or forms of an Electrically Programmable Memory (EPROM) or an Electrically Erasable and Programmable Memory (EEPROM).

In addition, the memory 120 may, in some examples, be considered a non-transitory storage medium. The term “non-transitory” may indicate that the storage medium is not embodied in a carrier wave or a propagated signal. However, the term “non-transitory” should not be interpreted that the memory 120 is non-movable. In some examples, the memory 120 can be configured to store larger amounts of information than the memory 120 respectively. In certain examples, a non-transitory storage medium may store data that can, over time, change (e.g. in Random Access Memory (RAM) or cache).

The processor 130 is configured to execute instructions stored in the memory 120. The communicator 140 is configured to communicate internally between hardware components in the MUSIM UE 100. Further, the communicator 140 is configured to facilitate the communication between the MUSIM UE 100 and the wireless communication network.

Although the FIG. 2A shows the hardware components of the MUSIM UE 100 but it is to be understood that other embodiments are not limited thereon. In other embodiments, the MUSIM UE 100 may include less or more number of components. Further, the labels or names of the components are used only for illustrative purpose and does not limit the scope of the invention. One or more components can be combined together to perform same or substantially similar function for managing the paging cause.

FIG. 2B illustrates a system 1000 for providing the paging cause to the MUSIM UE 100 in the wireless communication network, according to an embodiment as disclosed herein. In an embodiment, the system 1000 includes the AMF controller 200 and the RAN 300, where the AMF controller 200 is coupled to the RAN 300. In an embodiment, the AMF controller 200 includes an AI controller 210, a memory 220, a processor 230, and a communicator 240. In an embodiment, the RAN 300 includes an AI controller 310, a memory 320, a processor 330, and a communicator 340.

The AMF controller 200 is configured to receive the NAS request message with the AI request from the MUSIM UE 100. Further, the AMF controller 200 is configured to store the AI request received in the NAS request message. Further, the AMF controller 200 is configured to provide the NAS response message comprising the AI to the MUSIM UE 100.

In an embodiment, the AI controller 210 receives the NAS request message with the AI request from the MUSIM UE 100. Further, the AI controller 210 stores the AI request received in the NAS request message to the memory 220. Further, the AI controller 210 provides the NAS response message comprising the AI to the MUSIM UE 100.

In an embodiment, the AMF controller 200 is configured to send the AI request received from the MUSIM UE 100 to the RAN 300 for making a decision whether to provide the paging cause to the MUSIM UE 100. Further, the RAN is configured to receive the MUSIM AI from the AMF controller 200. Further, the RAN is configured to provide the paging message comprising the paging cause to the MUSIM UE 100 in an RRC inactive state as part of a RAN 300 paging procedure in response to determining that AMF AI indicates to provide the paging cause to the MUSIM UE 100.

In an embodiment, the AI controller 210 sends the AI request received from the MUSIM UE 100 to the RAN 300 for making the decision whether to provide the paging cause to the MUSIM UE 100. Further, the AI controller 310 receives the MUSIM AI from the AMF controller 200. Further, the AI controller 310 indicates whether the paging message should include the paging cause to the MUSIM UE 100 in the RRC inactive state as part of the RAN 300 paging procedure.

In another embodiment, the AMF controller 200 is configured to detect a trigger for a second paging message with a second paging cause. Further, the AMF controller 200 is configured to send the second paging message to the MUSIM UE 100, wherein the second paging message comprises at least one paging cause which is different from the paging cause of the first paging message to the MUSIM UE (100).

In an embodiment, the AI controller 210 detects the trigger for the second paging message with the second paging cause. Further, the AI controller 210 sends the second paging message to the MUSIM UE 100, wherein the second paging message comprises at least one paging cause of the second services pending to deliver for the MUSIM UE 100.

The memory 220 and the memory 320 can be same kind of the memory 120. The processor 230 is configured to execute instructions stored in the memory 220. The communicator 240 is configured to communicate internally between hardware components in the AMF controller 200. Further, the communicator 240 is configured to facilitate the communication between the AMF controller 200 and other devices (e.g. MUSIM UE 100, RAN 300, etc.).

The processor 330 is configured to execute instructions stored in the memory 320. The communicator 340 is configured to communicate internally between hardware components in the RAN 300. Further, the communicator 340 is configured to facilitate the communication between the RAN 300 and other devices (e.g. MUSIM UE 100, AMF controller 200, etc.).

Although the FIG. 2B shows the hardware components of the system 1000 but it is to be understood that other embodiments are not limited thereon. In other embodiments, the system 1000 may include less or more number of components. Further, the labels or names of the components are used only for illustrative purpose and does not limit the scope of the invention. One or more components can be combined together to perform same or substantially similar function for providing the paging cause to the MUSIM UE 100.

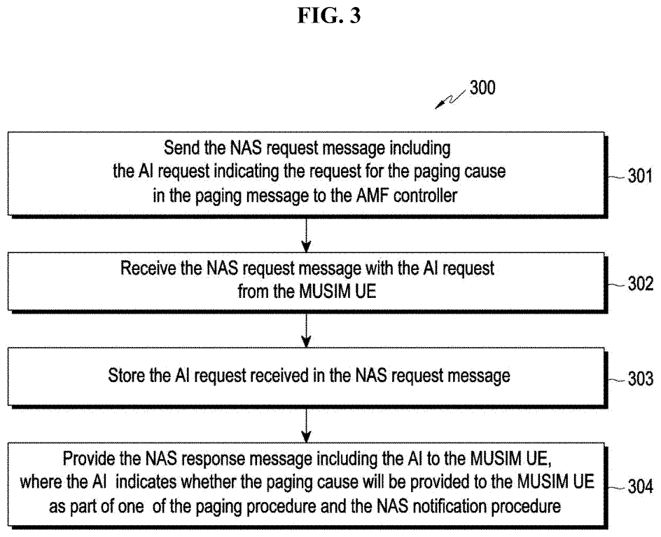

FIG. 3 is a flow diagram 300 illustrating a method for providing the paging cause to the MUSIM UE 100 in the wireless communication network, according to an embodiment as disclosed herein. At step 301, the method includes sending the NAS request message including the AI request indicating the request for the paging cause in the paging message to the AMF controller 200. In an embodiment, the method allows the NAS messaging controller 111 to send the NAS request message including the AI request indicating the request for the “paging cause in the paging message” to the AMF controller 200. At step 302, the method includes receiving the NAS request message with the AI request from the MUSIM UE 100. In an embodiment, the method allows the AI controller 210 to receive the NAS request message with the AI request from the MUSIM UE 100.

At step 303, the method includes storing the AI request received in the NAS request message. In an embodiment, the method allows the AI controller 210 to store the AI request received in the NAS request message. At step 304, the method includes providing the NAS response message including the AI to the MUSIM UE, where the AI indicates whether the paging cause will be provided to the MUSIM UE as part of one of the paging procedure and the NAS notification procedure. In an embodiment, the method allows the AI controller 210 to provide the NAS response message including the AI to the MUSIM UE, where the AI indicates whether the paging cause will be provided to the MUSIM UE as part of one of the paging procedure and the NAS notification procedure.

The various actions, acts, blocks, steps, or the like in the flow diagram 300 may be performed in the order presented, in a different order or simultaneously. Further, in some embodiments, some of the actions, acts, blocks, steps, or the like may be omitted, added, modified, skipped, or the like without departing from the scope of the invention.

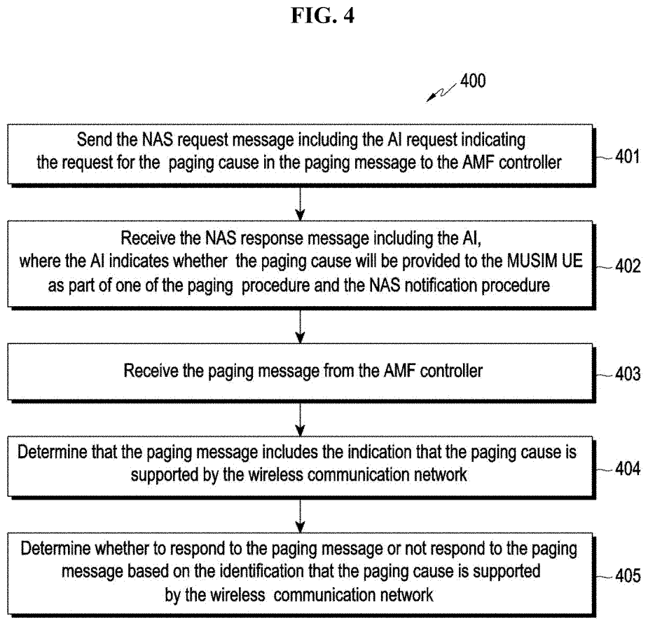

FIG. 4 is a flow diagram 400 illustrating a method for managing the paging cause in the wireless communication network, according to an embodiment as disclosed herein. At step 401, the method includes sending the NAS request message including the AI request indicating the request for the paging cause in the paging message to the AMF controller 200. In an embodiment, the method allows the NAS messaging controller 111 to send the NAS request message including the AI request indicating the request for the paging cause in the paging message to the AMF controller 200. At step 402, the method includes receiving the NAS response message including the AI, where the AI indicates whether the paging cause will be provided to the MUSIM UE 100 as part of one of the paging procedure and the NAS notification procedure. In an embodiment, the method allows the NAS messaging controller 111 to receive the NAS response message including the AI, where the AI indicates whether the paging cause will be provided to the MUSIM UE 100 as part of one of the paging procedure and the NAS notification procedure.

At step 403, the method includes receiving the paging message from the AMF controller 200. In an embodiment, the method allows the NAS messaging controller 111 to receive the paging message from the AMF controller 200. At step 404, the method includes determining that the paging message includes the indication that the paging cause is supported by the wireless communication network. In an embodiment, the method allows the NAS messaging controller 111 to determine that the paging message includes the indication that the paging cause is supported by the wireless communication network. At step 405, the method includes determining whether to respond to the paging message or not respond to the paging message based on the identification that the paging cause is supported by the wireless communication network. In an embodiment, the method allows the action controller 112 to determine whether to respond to the paging message or not respond to the paging message based on the identification that the paging cause is supported by the wireless communication network.

Practical issue with identification whether the paging cause is supported by the wireless communication network is that all the RAN nodes 300 (i.e. gNBs) cannot be upgraded in the network at the same time. It is quite possible that a gNB−1 is upgraded where as a gNB−2 is not upgraded to support the paging cause (or in general MUSIM feature). But both the gNBs can be connected to the same AMF controller 200. The AMF controller 200 supports the paging cause feature. Consider an example of a voice call when the AMF controller 200 sends the paging message through the gNB−1, the gNB−1 will page with the paging cause “voice” and if the paging cause is not any standard feature like internet user plane data, the AMF controller 200 will send the paging message again, then the gNB−1 will page the MUSIM UE 100 without including the paging cause. Similarly, if the MUSIM UE 100 is in a gNB−2 area, for both the “voice” and the “internet data” the MUSIM UE 100 will not receive the paging cause in the paging message. Thus, when the paging cause is not included, the MUSIM UE 100 cannot identify whether the paging message is from the gNB−1 or the gNB−2. Hence the MUSIM UE 100 cannot identifies whether the incoming paging message which does not include the paging cause is for the “Voice” or the “internet data”. Thus, the MUSIM UE 100 cannot makes a decision whether to respond to the paging or not respond to the paging message because the MUSIM UE 100 is not able to identify the incoming traffic i.e. downlink service. Hence there is a need to define a mechanism in which the MUSIM UE 100 will be able to identify if the current wireless communication network supports the paging cause. Following methods are proposed to identify if the current wireless communication network supports the paging cause (or in general MUSIM feature).

The paging message itself provides an information whether the paging cause is supported or not supported by the current serving network nodes (like the gNB and the AMF controller 200) for example the paging message can have a dedicated indication that the paging cause is supported by the network nodes, with this indication (or information) the MUSIM UE 100 identifies if the paging cause is supported or not and the MUSIM UE 100 can make appropriate decision.

In another embodiment, the network nodes always provide the paging cause to the MUSIM UE 100 (optionally on the UE request) even when the paging for services other than standard services, i.e. for nonstandard services like the internet data etc. can have the paging cause like “other services” or “other data” “default” or “other” etc. The set of standard services which are uniquely identified by the paging cause like voice, SMS, CP signalling, IMS signalling. With this dedicated paging cause for the nonstandard services the MUSIM UE 100 can identify that current serving network nodes supports the paging cause and if the paging cause is not included in the paging message then the MUSIM UE 100 can identify that the paging cause is not supported by the network nodes.

In another embodiment, the gNB can broadcast whether the paging cause is supported by the network nodes. Thus, each time when the paging message is received without the paging cause, the MUSIM UE 100 can check the broadcasted information to identify if the paging cause is supported or not supported by the network nodes. The broadcasted information can be on demand system information too, which can be requested on demand by the MUSIM UE 100. In this case when the broadcast information indicates the paging cause is supported by the network, but if no paging cause is included in the paging message then the MUSIM UE 100 identifies that paging is happening for the service which is not described in the paging cause list because the service not a standard service.

In another embodiment, the network nodes (either the gNB or the AMF controller 200) provides the paging cause supports indication to the MUSIM UE 100 for example in the AS message or the NAS message, this indication can be provided per cell, per TAI, per registration area (i.e. TAI list), or for given a geographical area like TAI list, a cell ID list etc. Thus, whenever the MUSIM UE 100 is in that particular geographical area the MUSIM UE 100 knows that current serving network nodes supports the paging cause. In this case when the MUSIM UE 100 is in the geographical area indicated by the network nodes (RAN 200 or the AMF controller 200), if no paging cause is provided to the MUSIM UE 100, then the MUSIM UE 100 identifies that the paging is happening for the service which is not described in the paging cause list because the service is not a standard service.

If the MUSIM UE 100 identifies that the paging cause is not supported by one or all of the serving network nodes (RAN 300 or AMF controller 200) i.e. this are legacy nodes, then if the paging message is received by the MUSIM UE 100 without the paging cause value, then the MUSIM UE 100 shall respond to the paging message. As the MUSIM UE 100 is not aware about the incoming service, only after the MUSIM UE 100 takes the incoming service after responding to the paging message, the MUSIM UE 100 will be able to identify if the incoming service is priority or non-priority service.

The various actions, acts, blocks, steps, or the like in the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

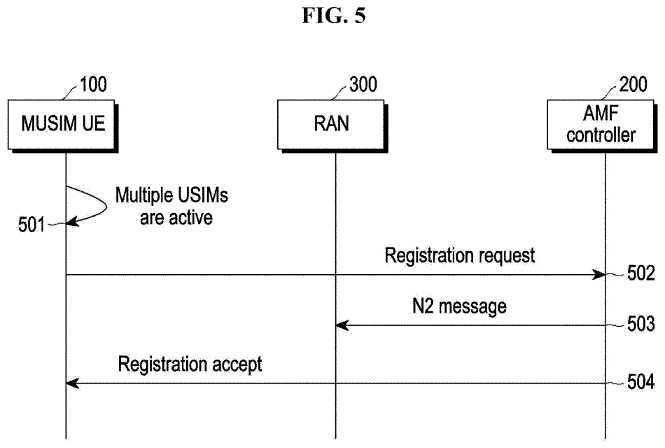

FIG. 5 is a signaling diagram illustrating a registration procedure in the wireless communication network, according to an embodiment as disclosed herein. In an embodiment, only the MUSIM UE 100 with more than one USIM currently active and wants to optimize USIM operations should request the network (i.e. the AMF controller 200 or RAN 300) to provide the AI to the MUSIM UE 100. Please note this does not mean the MUSIM UE 100 with a MUSIM capability can request for AI. For example, the MUSIM UE 100 may be DSDS capable but if a second USIM is not inserted, the AI is not useful to the MUSIM UE 100. In an embodiment, the MUSIM UE 100 can make a request for the AI as a part of a registration procedure, both during an initial registration procedure and a mobility registration update procedure or any other NAS procedure or as part of an access stratum procedure. The mobility registration update procedure can be used to change a negotiated value dynamically. For example, if a UE condition changes and the second USIM is removed from the MUSIM UE 100 and not more than USIMs are active on the MUSIM UE 100 or user configuration has made only one SIM active and all other SIMs as passive.

In an embodiment, if the AMF controller 200 wants to activate the RRC Inactive state for the MUSIM UE 100, then a “request for AI” flag is provided by AMF controller 200 to the NG-RAN 300 (g-Node B) for example along with an RRC Inactive AI. The term AI indicates type of traffic pending to be delivered to the MUSIM UE 100 over the 3GPP access for example the IMS voice call, the IMS SMS, the video call etc.

Providing AI required flag to the network as shown in the FIG. 5 The proposed method is for the network to know if the network has to provide the AI to the MUSIM UE 100. It is proposed that MUSIM UE 100 indicates that the MUSIM UE 100 needs the AI to the AMF controller 200 as part of the registration procedure. The AMF controller 200 can indicate “UE needs the AI” along with the RRC Inactive AI to the RAN 300 when activating the RRC Inactive state. The RAN node 300 will use this information to determine if a RAN paging should contain the AI or not. The proposed method can also be used in EPS with the following changes:

The AMF controller 200 in the description above is replaced with a MME. No information is provided to the RAN.

Procedures: The proposed method has impact on the Registration procedure in 3GPP TS 23.502 sub-clause 4.2.2.2. The changes relative to the existing procedure are indicated below. Only the impacted steps are shown in the FIG. 5 (Registration procedure (Impacted steps from TS 23.502).

At step 501, the MUSIM UE 100 having more than one USIM active initiates the registration procedure as described in the 3GPP TS 23.502 sub-clause 4.2.2.2.2.

At step 502, the MUSIM UE 100 sends the NAS message for example a registration request message including the AI requested to the AMF controller 200. The MUSIM UE 100 sending the AI requested to the AMF controller 200 is not only based on the UE capability. The MUSIM UE 100 will request for the AI only if more than one USIMs are active and the MUSIM UE 100 constraints requires the AI for efficient MUSIM operations. For example, Single Rx/Tx UE which cannot operate simultaneously with the both the network at the same time.

At step 503, the AMF controller 200, if wants to activate the RRC Inactive state for the MUSIM UE 100, then AMF controller 200 sends the value received in the AI requested from the MUSIM UE 100 (optionally along with the RRC Inactive AI) to the RAN. So that the RAN 300 can provide the AI to the MUSIM UE 100 in the RRC Inactive state as part of the RAN paging procedure

At step 504, as part of the NAS message (for example Registration Accept), the network decides and indicates to the MUSIM UE 100 that the network will provide the AI to the MUSIM UE 100 as part of the paging message or the notification message. The network indicates based on local policy or subscription information (e.g. received from UDM) that AI will be provided to the MUSIM UE 100.

In yet another embodiment, the AMF controller 200 or the RAN nodes 300 provide the AI to the MUSIM UE 100 only if the AI is requested by the MUSIM UE 100 in the NAS procedure or AS procedure and the network decides to provide the AI. Otherwise, the network will not provide the AI to the MUSIM UE 100. When AMF controller 200 knows that the MUSIM UE 100 has the MUSIM capability based on negotiation with the MUSIM UE 100, the AMF controller 200 shall increase a mobile reachable timer or an implicitly deregistration timer as the MUSIM UE 100 might be busy performing higher priority operations on another SIM and may not perform the periodic update procedure with the network exactly at the expiry of a periodic timer expiry. An increase in the mobile reachable timer or the implicitly deregistration timer can be based on just increasing a time of the timer when compared to other users or just restarting the timer and not taking any action each time, the timer expires for x restarts. After x restarts, the AMF controller 200 can decide to perform implicit deregistration.

When the paging message is received by the MUSIM UE 100 and if there is no AI is included then the MUSIM UE 100 shall respond to the paging procedure by executing an appropriate NAS procedure. For example, a service request procedure in a normal service state, or a registration procedure in attempting to update a state.

When the paging message is received by the MUSIM UE 100 and if there is no AI is included then the MUSIM UE 100 shall respond to the paging procedure by executing an appropriate NAS or AS procedure. For example, by executing resume procedure and get into connected mode. Optionally, the MUSIM UE 100 shall respond to the paging mandatorily when no AI is received can be based on negotiation between the MUSIM UE 100 and the network that the AI will be shared as part of the paging message to the MUSIM UE 100. i.e. the MUSIM UE 100 requests to provide the AI and the network in a registration accept indicate to the MUSIM UE 100 that it will be provided.

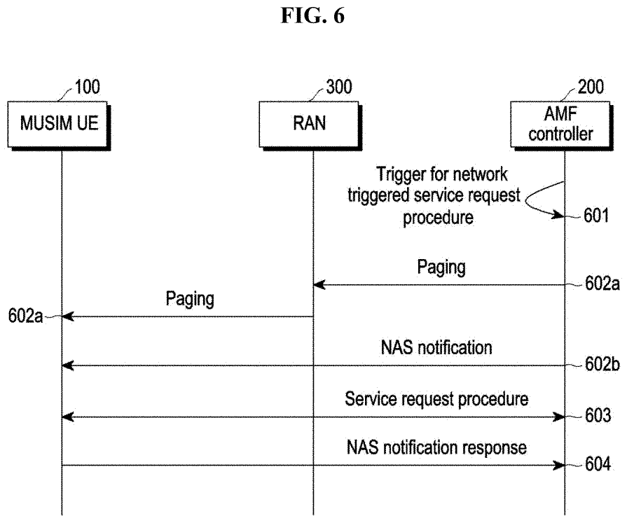

FIG. 6 is a signaling diagram illustrating a procedure for providing the AI in a CM_IDLE state in the wireless communication network, according to embodiments as disclosed herein. In an embodiment, the method can be used to indicate a CP signaling that is pending for the MUSIM UE 100 with the AI “CP signaling” so that the CP signaling can be differentiated over internet PS data in the MUSIM UE 100 implementations. Here, the CP Signaling is a name used to indicate a control plane downlink message from the AMF controller 200 and this is just an example. This can have further granularity like each NAS or SM message can have a different AI value with which it can be identified, for example a network initiated detach, DL NAS TRANSPORT or a UE configuration update message all can have different AI values to the MUSIM UE 100. In an embodiment, the method can be used to avoid possible ambiguity in the MUSIM UE 100 implementations. It is proposed that the 3GPP system shall provide a Mission Critical Service (MCS), emergency service as the AI to the MUSIM UE 100.

Based on the above observations following AI table is proposed.

| Service | |
|---|---|
| category ID | Type of downlink traffic |
| 0 | MCS, MPS, Emergency services (Critical services). |
| 1 | CP signaling. |
| 2 | Other-data |

The steps for providing the AI in the CM_IDLE state is given below:

At step 601, conditions to initiate a network triggered service request procedure for a downlink data or signalling over a 3GPP access are met as specified in a 3GPP TS 23.502 sub-clause 4.2.3.3.

At step 602a, if the AMF controller 200 decides to send the paging message without setting an access to a “non-3GPP” as specified in the 3GPP TS 23.502 sub-clause 4.2.3.3, then the AMF controller 200 may include the AI indicating the type of traffic pending for the MUSIM UE 100 over the 3GPP access.

At step 602b, if the AMF controller 200 decides to send a NAS notification message containing a 3GPP access type to the MUSIM UE 100 over the non-3GPP access as specified in the 3GPP TS 23.502 sub-clause 4.2.3.3, then the AMF controller 200 may include the AI indicating the type of traffic pending for the MUSIM UE 100 over the 3GPP access. In an embodiment, the decision of the AMF controller 200 to provide the AI to the MUSIM UE 100 is based on the request from the MUSIM UE 100 to provide the AI as part of the NAS procedure.

At step 603, the MUSIM UE 100 may choose to respond the paging message or the NAS notification message based on the AI received in the respective message by executing the NAS procedure. For example, a service request procedure (if in NORMAL SERVICE state) or the mobility and registration update procedure (in attempting to update state) as described in 3GPP TS 23.502.

At step 603, if the MUSIM UE 100 is simultaneously registered over the 3GPP and non-3GPP accesses in a same PLMN and if the MUSIM UE 100 decides to not respond to the NAS notification message or the paging message of the step 602a or the step 602. For example, as the MUSIM UE 100 is busy with higher priority operations on the another USIM of the same devices then the MUSIM UE 100 shall respond with the NAS notification response message over the non-3GPP access to indicate the same to the network. The NAS notification message may include a timer value until which the network should not send the paging message or the NAS notification message to the MUSIM UE 100 for the downlink data or signalling over the 3GPP access with the same AI, where the timer value is determined based on a UE implementation. Upon reception of the NAS notification response message, the network shall restart the mobile reachable timer and implicit detach the timer. At the same time, the MUSIM UE 100 shall restart a periodic registration timer. In yet another embodiment, the notification response message from the MUSIM UE 100 can clearly indicate the cause that the MUSIM UE 100 is busy doing some other operations for example on another USIM, thus it is not responding with this information, the network shall restart the mobile reachable timer and implicit detach the timer. At the same time, the MUSIM UE 100 shall restart the periodic registration timer.

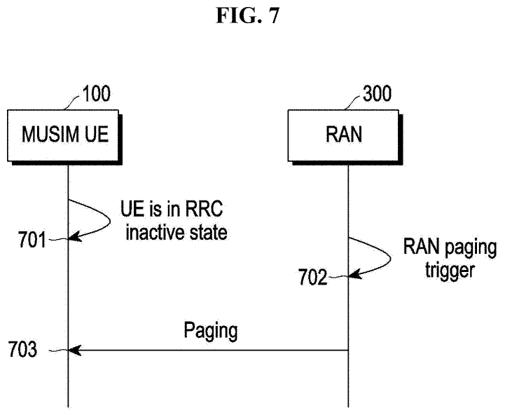

FIG. 7 is a signaling diagram illustrating a procedure for providing the AI in the RRC Inactive state in the wireless communication network, according to embodiments as disclosed herein. Steps in the procedure for providing the AI in the RRC inactive state is given below:

At step 701, the MUSIM UE 100 is in RRC inactive state.

At step 702, the trigger to perform the RAN paging is met (for example incoming DL user plane, DL signaling from 5GC, etc.) as described in 3GPP TS38.300 sub-clause 9.2.2.4.2.

At step 703, if the RAN 300 is notified by AMF controller 200 that the MUSIM UE 100 requested for the AI as part of a N2 message then the RAN 300 may include the AI in the paging message. Further, the MUSIM UE 100 may choose to respond the paging message based on the AI received and get into the connected mode as described in 3GPP TS38.300.

Handling of dual registration is described below:

Doing a dual registration, as per a current specification is restricted to a case that the PLMNs that the MUSIM UE 100 is attempting to register should either be the same or equivalent PLMNs. But there are certain use cases like below, where it is necessary that the PLMNs need not be the same or equivalent, due to operator's deployment requirements.

Below is an example of one such scenario:

1) An operator has a PLMN A deployed in a NGRAN/5GS.

2) The PLMN A and a PLMN B are deployed in a EUTRAN.

3) The PLMN A and the PLMN B are the equivalent PLMNs and support an “interworking without N26”.

4) The operator wants dual registered UEs to register on the PLMN A in the 5GS and to register on the PLMN B in the EPS.

5) The operator at the same time wants to restrict IRAT movements of these UEs between the PLMNs deployed in the EUTRAN (i.e. the PLMN A and the PLMN B).

With a current mandate in the specification that only the same or equivalent PLMNs are allowed to be selected in the dual registration mode, supporting the above-mentioned configuration would not be possible with the current implementation. Additionally, there may be use cases where the operators would want to support the dual registration across different VPLMNs to be able to access different services without a session transfer. The current definition of the feature does not allow the same. The below proposal looks at ways in which the network can enable a UE to operate in the dual registration mode across the PLMNs which are different and not equivalent PLMNs.

Solution 1: Provide a set of PLMNs that the MUSIM UE 100 is allowed to register on simultaneously for the dual registration. The above list can be provided when the MUSIM UE 100 does the registration on one of RATs. The list can be made more specific by providing a PLMN+RAT combination in case the network wants to restrict certain PLMNs to certain RATs. The list can also include the PLMN+RAT set as pairs, such that a possible combination of operations is notified to the MUSIM UE 100. These details can as well be pre-configured in the MUSIM UE 100.

Solution 2: Allow the MUSIM UE 100 to follow a priority defined in a UPLMN/OPLMN list. The UPLMN/OPLMN list defines most probable PLMNs where the MUSIM UE 100 can get the service and their priority. Considering the following use case: the MUSIM UE 100 has the PLMN A, the PLMN B, a PLMN C in that order from higher to lower priority. The MUSIM UE 100 registers on the PLMN A in a N1 Mode and receives the PLMN C as the equivalent PLMN. The MUSIM UE 100 registers on the PLMN C in Si mode in spite of the fact that a coverage of the PLMN B is available in that area in the EUTRAN. Since, the equivalent PLMN is decided by the VPLMN, it is possible that in certain use cases a HPLMN's preference list does not align with a VPLMN's preference. In such use cases the MUSIM UE 100 might be restricted from moving to a more preferred VPLMN as per a HPLMN preference. To avoid such conflicts and to go by the preference of the HPLMN lists, the dual registration can be done on individual RATs based on existing PLMN selection principles and by selecting the most preferred PLMN in each RAT. The MUSIM UE 100 can restrict this behaviour to use cases where it does not expect a session handover across the RATs.

Solution 3: Method for the network to decide EPLMNs based on the MUSIM UE 100 sending “UE status information element”. The UE status Information Element (IE), based on the value that is sent in this IE, is used to derive whether the MUSIM UE 100 is operating in a single or dual registration mode. A network which wants to selectively assign the EPLMNs to only to UEs that operate in the single registration mode can use this IE to differentiate the UEs registration mode (i.e. single or dual) and can decide on sending the EPLMNs accordingly. So, the network that wants to restrict the dual registered MUSIM UE 100 from reselecting across the PLMNs in the EUTRAN can use this IE to not send the EPLMNs in the EUTRAN.

Since, the EPLMNs are maintained on a per RAT basis during dual registration, the same network can send the PLMNs in the EPLMN list for the UE's registration in a N1 mode. Thus, the MUSIM UE 100 status IE can be used by the network to selectively control the EPLMN list on a per RAT basis. If the network has received the request to provide the AI to the MUSIM UE 100 then network will should not filter the paging.

The AI is also called as paging cause in this embodiment means the type of traffic pending to be delivered to the MUSIM UE 100 over the 3GPP access. Using the AI, the MUSIM UE 100 can make a decision whether to respond to the paging or not, based on current activities in the MUSIM UE 100 for example if there is a higher priority services ongoing on the other USIM.

The network (i.e. the AMF controller 200 or gNodeB) shall not provide the paging cause if an incoming traffic is for priority services (also called as critical services) like the emergency services/the MCS services/the MPS services etc. If there is no AI it means the network has paged the MUSIM UE 100 for priority services thus the MUSIM UE 100 is required to respond to the paging message. Optionally this behaviour in the network and the MUSIM UE 100 is implemented only if the MUSIM UE 100 and the network successfully negotiated that the AI will be provided to the MUSIM UE 100 in the NAS or AS procedures.

If the MUSIM UE 100 and the network successfully negotiated that the AI will be provided to the MUSIM UE 100 in the NAS or AS procedures, the RAN 300 shall increase the value of a RNA update timer on the gNodeB side, whenever it expires, the RAN layer 300 shall restart the timer without impacting an inactive state context for an implementation dependent number of times, because the MUSIM UE 100 can be in the dual SIM operations and may not be able to perform a periodic RAN area update procedure at an expiry of the RNA timer (i.e. the periodic timer in the inactive state).

Consider an example, the AMF controller 200 has triggered the paging procedure with the AI value AIL now following the existing procedure the AMF controller 200 determines that another paging has to be triggered (optionally it may be of the lower priority as per local configuration when compared to the first paging message sent) however it is with different AI value AI2. The AMF controller 200 shall trigger a second paging procedure without waiting for the MUSIM UE 100 to respond to the first paging because for the first paging request the MUSIM UE 100 may not respond based on the AI value. In another words, the AMF controller 200 need not page the MUSIM UE 100 if the second requests turn out to be for the same AI value. The same procedure has to be applied by the gNodeB (i.e. RAN node 300) for the RAN paging in the RRC inactive state too. This means that there can be multiple paging messages sent to the same MUSIM UE 100 with different assistance values. Also, the MUSIM UE 100 is expected to read all the paging message and lower layers in the MUSIM UE 100 should report all the received paging messages with the assistance values to a NAS layer. Optionally this behaviour of the AMF controller 200 or the RAN nodes 300 can be done if the MUSIM UE 100 and the network successfully negotiated that the AI will be provided to the MUSIM UE 100 in the NAS or AS procedures.

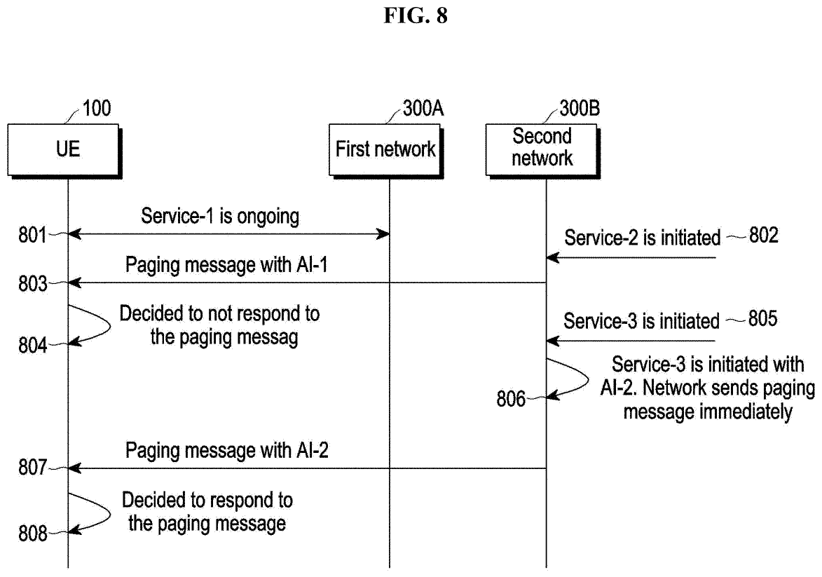

FIG. 8 is a signalling diagram illustrating initiating a second paging procedure by the AMF controller 200 or the gNodeB even the first paging procedure is incomplete, according to the embodiments as disclosed herein. The AMF controller 200 can get to know that the UE is the MUSIM UE 100 thus it may decide to not respond to the paging based on the paging cause. Consider, a service-1 is ongoing (801) between the MUSIM UE 100 and a first network 300A corresponds to the first USIM of the MUSIM UE 100. A second network 300B corresponds to the second USIM of the MUSIM UE 100 initiates (802) a service-2 for the MUSIM UE 100. For the downlink (DL) data or signalling, the AMF controller 200 sends (803) the first paging message to the MUSIM UE 100 with AI value AI−1. Now again the DL data or signalling is initiated (805) in the core network for the same USIM stack (i.e. the MUSIM UE 100), the AMF controller 200 shall send (806,807) the second paging request immediately to the MUSIM UE 100 which is with different AI values (i.e. AI−2). So that the MUSIM UE 100 can get to know about the new pending downlink service for it and can decide (808) whether to responds to the second paging message.

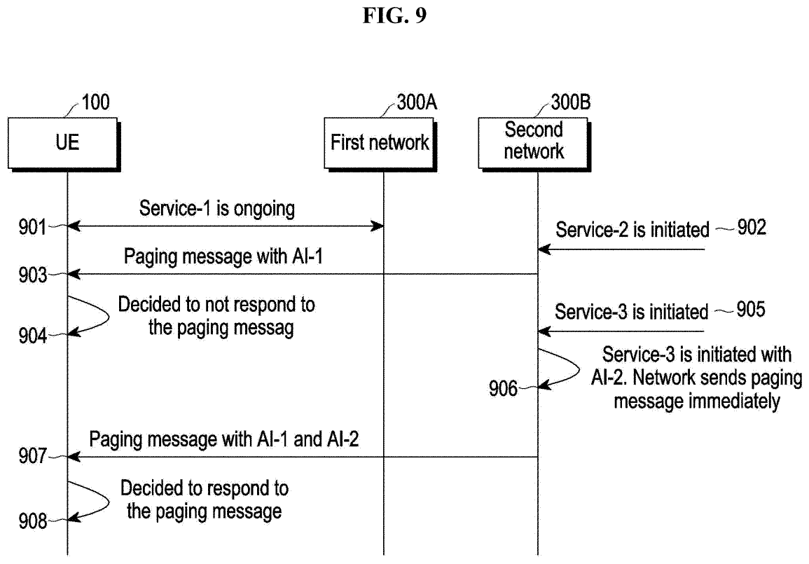

FIG. 9 is a signalling diagram illustrating a transmission of the second paging message with multiplexing the AI values by the AMF controller 200 or the gNodeB, according to the embodiments as disclosed herein. Consider, the service-1 is ongoing (901) between the MUSIM UE 100 and the first network 300A corresponds to the first USIM of the MUSIM UE 100. The second network 300B corresponds to the second USIM of the MUSIM UE 100 initiates (902) the service-2 for the MUSIM UE 100. The AMF controller 200 has triggered (903) the paging procedure with the AI value AI−1. When MUSIM UE 100 receives the paging because it may decide (904) to not respond to paging. One reason could be that particular service MUSIM UE 100 has aborted thus it becomes a lower priority. For example, a related PDU session is already deactivated by the MUSIM UE 100 locally. However, as the network has no information about the local deactivation of the service. It continuous to page the MUSIM UE 100. In general implementations this may cause the paging procedure to be escalated in larger areas.

The second network 300B can send (906, 907) the second paging request to the MUSIM UE 100 or multiplex all the AI values into the same paging request message to the MUSIM UE 100. i.e. the second paging message will have all the AI values corresponding to respective services multiplexed with which are pending to delivered to the MUSIM UE 100. Multiplexing of the AI values can be done by the AMF controller 200 or the g-Node B as per the proposed method. The MUSIM UE 100 is expected to read all the paging messages or all the values of the AI values to identify the type of traffic incoming to the MUSIM UE 100 in a DL direction. So that the MUSIM UE 100 can make informed decision (908) to respond or not to respond to the paging message.

The second paging message, with or without multiplexing the AI values as described in the proposed method can be done only if the MUSIM UE 100 and the AMF controller 200 negotiate that MUSIM UE 100 is having communication constraints due to which it needs the AI. The AI in this invention is the value along with the paging or the notification message sent by the second network 300B which indicates to the MUSIM UE 100 the type of data traffic or signalling traffic (or in other words service) pending to be delivered to the MUSIM UE 100. Further, the second network decides to send second paging message to the MUSIM UE 100 only if the AI value is different from the first paging message AI value or different from the last multiplexed AI values. The proposed method is described with respect to the AMF controller 200 or CN entity same invention is applicable for the RAN paging when the MUSIM UE 100 is in INACTIVE state. The paging cause and the AI values are the terms used interchangeably.

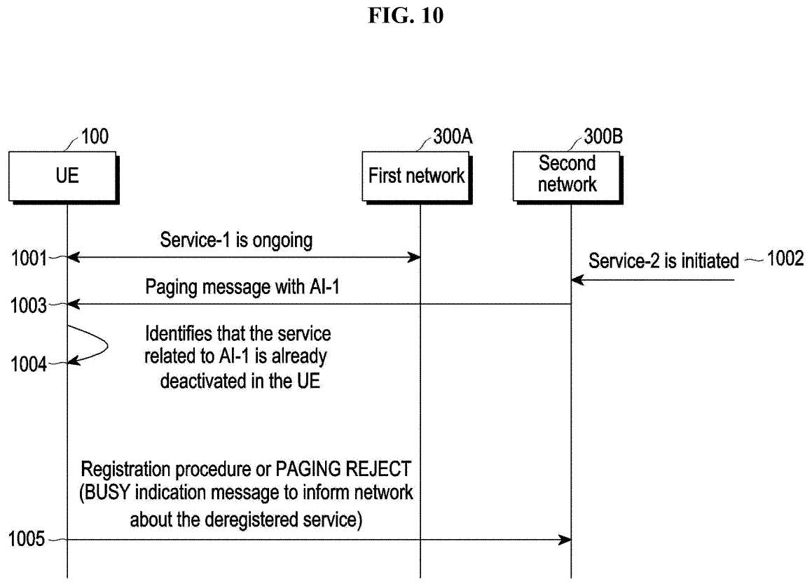

FIG. 10 is a signalling diagram illustrating a scenario of triggering the NAS or AS procedure by the MUSIM UE 100 to inform a deactivated state of the service to the second network 300B, according to the embodiments as disclosed herein. Consider, the service-1 is ongoing (1001) between the MUSIM UE 100 and the first network 300A corresponds to the first USIM of the MUSIM UE 100. The second network 300B corresponds to the second USIM of the MUSIM UE 100 initiates (1002) the service-2 for the MUSIM UE 100. In the conventional methods and systems, consider that the AMF controller 200 has triggered the paging procedure with AI value AI−1. When the MUSIM UE 100 receives the paging cause, it may decide to not respond to the paging. One reason could be that particular service the MUSIM UE 100 has aborted thus it becomes lower priority. For example, the related PDU session is already deactivated by the MUSIM UE 100 locally. However, as the second network 300B has no information about the local deactivation of the service. It continuous to page the MUSIM UE 100. In general implementations this may cause the paging procedure to be escalated in larger areas.

Referring to the FIG. 10, when the MUSIM UE 100 receives (1003) the paging with the paging cause (in other words AI) w.r.t to which the MUSIM UE 100 has already deactivated (1004) the services (for example the PDU session) the MUSIM UE 100 shall trigger the NAS or AS procedure to inform the deactivated state of the service to the network. For example: by triggering the registration procedure or the service request procedure (with the PDU session status IE). The PDU session status IE will indicate the respective PDU session which is already released on the MUSIM UE 100 side. By triggering registration procedure to indicate the SMS or LCS is no more supported by the MUSIM UE 100. By triggering (1005) a paging reject message or a BUSY indication message to the second network 300B including PDU session status IE or indicating deregistration of SMS (in general any service). With this information the second network 300B will also deactivate respective service, for example by releasing the PDU session or the SMS service deregistration and this will avoid the second network 300B to page to the MUSIM UE 100.

In general, when the AMF controller 200 has sent the paging message to the MUSIM UE 100 with the paging cause (AI−1) and a new trigger is generated at the core network, the AMF controller 200 shall take into account what is the paging cause of the second paging message. If the paging cause of the second paging message is different from the first already sent paging cause of the first paging message then AMF controller 200 can execute one of the below mechanisms.

1. The AMF controller 200 shall send the second paging message immediately by multiplexing both the paging causes of the first paging message and the second paging message.

2. The AMF controller 200 shall send the second paging message immediately. The AMF controller 200 and the gNB shall execute both the paging procedures simultaneously and in parallel with their own implementation dependent retry counts. The first paging procedure should not impact the execution of the second paging procedure and vice versa.

3. The AMF controller 200 can inform a SMF that this paging procedure should be retried after a particular duration, where the SMF will send the paging message again after that particular duration is expired (example maintained by timer).

4. The AMF controller 200 shall remember that second paging procedure is pending, if the MUSIM UE 100 does not respond to the first paging procedure, (optionally after the paging guard timer expiry), the AMF controller 200 shall execute the second paging procedure mandatorily.

5. As the first paging procedure is ongoing. The second paging procedure can be initiated by the AMF controller 200 or the SMF or after interaction between the AMF controller 200 and the SMF after retry duration. Basically, core network (AMF controller 200, the SMF and a UPF) should remember that they have to also send the second paging message even if the first paging procedure expires and the MUSIM UE 100 has not responded to the first paging message. i.e. the SMF and the UPF and can indicate to the AMF controller 200 that downlink data is pending of the second paging message after retry duration. The retry duration timer can be started either at the AMF controller 200, the SMF or the UPF or any other core network entity.

When the MUSIM UE 100 decides to not respond to the paging message based on the paging cause, the MUSIM UE 100 will provide a busy indication to the network as part of the NAS or AS message. Then the MUSIM UE 100 shall also include the paging cause based on which the MUSIM UE 100 decided not to respond to the paging message as part of the NAS message with the busy indication or the AS message with the busy indication. So that the network can accurately identify if the busy indication is for the first paging message or the second paging message or nth Paging message. If the paging cause was not included then the MUSIM UE 100 shall make an explicit indication that the MUSIM UE 100 did not respond to paging without the paging cause as part of the busy indication e.g. by not including the paging cause in the NAS or AS message with the busy indication or with a dedicated information element. The explanation in this embodiment is with respect to first, second paging messages, but this can be extended to n number of paging procedures.

This embodiment is discussed from the core network elements of 5GS as an example but same invention is applicable to 4GS too with MME taking a role of the AMF controller 200 and eNodeB taking the role of the RAN node 300 (like gNB) etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-14. (canceled)

15. A method for receiving a paging message by a user equipment (UE) in a wireless communication system supporting multi-universal subscriber identity modules (USIMs), the method comprising:
receiving the paging message via a radio access network (RAN) from an access and mobility management function (AMY);
identifying whether the paging message includes a paging cause indication for a voice service; and
determining whether to respond to the paging message based on the paging cause indication in case that the paging message includes the paging cause indication.

16. The method of claim 15, wherein the UE in a radio resource control (RRC) inactive state receives the paging message which is a RAN paging message, and
wherein the multi-USIMs being active on the UE.

17. The method of claim 15, wherein the UE determines that the RAN supports the paging cause indication for the voice service in case that the paging message includes the paging cause indication, and
wherein the UE determines that the RAN does not supports the paging cause indication for the voice service in case that the paging message does not include the paging cause indication.

18. The method of claim 15, further comprising performing a service request procedure in case that the UE determines to respond to the paging message.

19. The method of claim 15, further comprising rejecting the paging message in case that the UE determines not to respond to the paging message.

20. The method of claim 15, further comprising transmitting, to the AMF via the RAN, a registration request message including information indicating that a capability for the multi-USIMs is supported in the UE; and
receiving, via the RAN from the AMF, a registration accept message including information indicating whether the paging cause indication for the voice service is supported in a network.

21. The method of claim 15, wherein the UE does not support a capability for the multi-USIMs in case that one USIM among the multi-USIMs is active on the UE.

22. The method of claim 15, further comprising transmitting, to the AMF via the RAN, information indicating that the UE does not support a capability for the multi-USIMs in case that one USIM among the multi-USIMs is active on the UE.

23. A user equipment (UE) in a wireless communication system supporting multi-universal subscriber identity modules (USIMs), the UE comprising:
a communicator; and
a processor configured to:
receive, through the communicator, a paging message via a radio access network (RAN) from an access and mobility management function (AMF),
identify whether the paging message includes a paging cause indication for a voice service, and
determine whether to respond to the paging message based on the paging cause indication in case that the paging message includes the paging cause indication.

24. The UE of claim 23, wherein the UE in a radio resource control (RRC) inactive state receives the paging message which is a RAN paging message, and
wherein the multi-USIMs being active on the UE.

25. The UE of claim 23, wherein the processor is configured to determine that the RAN supports the paging cause indication for the voice service in case that the paging message includes the paging cause indication, and
wherein the processor is configured to determines that the RAN does not supports the paging cause indication for the voice service in case that the paging message does not include the paging cause indication.

26. The UE of claim 23, wherein the processor is further configured to perform a service request procedure in case that the UE determines to respond to the paging message.

27. The UE of claim 23, wherein the processor is further configured to reject the paging message in case that the UE determines not to respond to the paging message.

28. The UE of claim 23, wherein the processor is further configured to transmit, to the AMF via the RAN, through the communicator, a registration request message including information indicating that a capability for the multi-USIMs is supported in the UE, and
receive, via the RAN from the AMF, a registration accept message including information indicating whether the paging cause indication for the voice service is supported in a network.

29. The UE of claim 23, wherein the UE does not support a capability for the multi-USIMs in case that one USIM among the multi-USIMs is active on the UE.

30. The UE of claim 23, the processor is further configured to transmit, to the AMF via the RAN, through the communicator, information indicating that the UE does not support a capability for the multi-USIMs in case that one USIM among the multi-USIMs is active on the UE.

31. A method for transmitting a paging message by an access and mobility management function (AMF) in a wireless communication system supporting multi-universal subscriber identity modules (USIMs), the method comprising:
receiving, via a radio access network (RAN) from a user equipment (UE), a registration request message including information indicating that a capability for the multi-USIMs is supported in the UE;
transmitting, to the UE via the RAN, a registration accept message including information indicating whether a paging cause indication for a voice service is supported in a network; and
transmitting, to the UE via the RAN, a paging message including the paging cause indication for the voice service.

32. The method of claim 31, wherein the paging message is a RAN paging message, and
wherein the multi-USIMs being active on the UE in a radio resource control (RRC) inactive state.

33. An access and mobility management function (AMF) in a wireless communication system supporting multi-universal subscriber identity modules (USIMs), the AMF comprising:
a communicator; and
a processor configured to:
receive, via a radio access network (RAN) from a user equipment (UE), through the communicator, a registration request message including information indicating that a capability for the multi-USIMs is supported in the UE,
transmit, to the UE via the RAN, through the communicator, a registration accept message including information indicating whether a paging cause indication for a voice service is supported in a network, and
transmit, to the UE via the RAN, through the communicator, a paging message including the paging cause indication for the voice service.

34. The AMF of claim 33, wherein the paging message is a RAN paging message, and
wherein the multi-USIMs being active on the UE in a radio resource control (RRC) inactive state.
